(19) United States
(12) Patent Application Publication
(10) Pub. No.: US 2025/0356595 A1
(43) Pub. Date: Nov. 20, 2025

(54) APPARATUS FOR CONTROLLING ELECTRONIC DEVICE THROUGH NON-FUNGIBLE TOKEN, AND METHOD THEREFOR

(71) Applicant: SAMSUNG ELECTRONICS CO., LTD., Suwon-si (KR)

(72) Inventors: Byeongyeon KIM, Suwon-si (KR); Donghyun SOHN, Suwon-si (KR)

(73) Assignee: SAMSUNG ELECTRONICS CO., LTD., Suwon-si (KR)

(21) Appl. No.: 19/287,977

(22) Filed: Aug. 1, 2025

Related U.S. Application Data
(63) Continuation of application No. PCT/KR2023/019912, filed on Dec. 5, 2023.

(30) Foreign Application Priority Data
Feb. 2, 2023 (KR) 10-2023-0014509

(51) Int. Cl. G06T 19/00; G06F 21/10

(52) U.S. Cl. CPC G06T 19/00; G06F 21/1014; G06T 2219/024

(57) ABSTRACT

A method performed by a server including receiving, from a first electronic device, a first signal including control information for an IoT device; acquiring a non-fungible token (NFT) including the control information; displaying, through a virtual space, a first virtual object representing the IoT device; receiving, from a second electronic device having acquired the control information through the first virtual object in the virtual space, a third signal including an instruction to control an operation of the IoT device; and transmitting, to the IoT device, a fourth signal requesting an operation of the IoT device, and displaying, through the virtual space, a second virtual object representing the IoT device modified according to the result of the instruction.

### CROSS-REFERENCE TO RELATED APPLICATIONS

This application is a continuation application, under 35 U.S.C. § 111 (a), of International Patent Application No. PCT/KR2023/019912, filed on Dec. 5, 2023, which based on and claims benefit of priority under 35 U.S.C. § 119 to Korean Patent Applications No. 10-2023-0014509, filed on Feb. 2, 2023, in the Korean Intellectual Property Office, the disclosures of which are incorporated by reference herein in their entireties.

### TECHNICAL FIELD

The present disclosure relates to a device for controlling an electronic device via a non-fungible token (NFT) and a method therefor.

### BACKGROUND ART

A non-fungible token (NFT) may indicate a virtual token generated using blockchain technology. The NFT may include digital data.

In order to provide an enhanced user experience, an electronic device that provides an augmented reality (AR) service displaying information generated by a computer in connection with an external object in the real-world is being developed. The electronic device may display a virtual space including the augmented reality. The virtual space may include a visual object (or an avatar) corresponding to content.

### DISCLOSURE

### Technical Solution

According to an embodiment, a method performed by a server may comprise receiving, from a first electronic device, a first signal including control information for an internet of things (IoT) device. The method may comprise obtaining a non-fungible token (NFT) including the control information. The method may comprise, based on receiving, from the first electronic device, a second signal, displaying, via a virtual space, a first virtual object representing the IoT device. The method may comprise receiving, from a second electronic device obtaining the control information via the first virtual object in the virtual space, a third signal including an instruction to control an operation of the IoT device. The method may comprise, based on receiving the third signal, transmitting, to the IoT device, a fourth signal requesting an operation of the IoT device and displaying, via the virtual space, a second virtual object representing the IoT device changed according to a result of the instruction.

According to an embodiment, a server may comprise communication circuitry. The server may comprise memory. The server may comprise a processor operatively connected to the communication circuitry and the memory. The processor may be configured to receive, from a first electronic device, a first signal including control information for an internet of things (IoT) device. The processor may be configured to obtain a non-fungible token (NFT) including the control information. The processor may be configured to, based on receiving, from the first electronic device, a second signal, display, via a virtual space, a first virtual object representing the IoT device. The processor may be configured to receive, from a second electronic device obtaining the control information via the first virtual object in the virtual space, a third signal including an instruction to control an operation of the IoT device. The processor may be configured to, based on receiving the third signal, transmit, to the IoT device, a fourth signal requesting an operation of the IoT device and display, via the virtual space, a second virtual object representing the IoT device changed according to a result of the instruction.

According to an embodiment, a method performed by an internet of things (IoT) server managing an IoT device may comprise receiving, from a first electronic device, a first signal including control information for the IoT device. The method may comprise transmitting, to a blockchain network connected to the IoT server, a signal for requesting to generate a non-fungible token (NFT) including the control information for the IoT device. The method may comprise receiving, from a metaverse server managing a virtual space, a signal including an instruction to control an operation of the IoT device based on the NFT. The method may comprise transmitting, to the IoT device, the signal including the instruction. The method may comprise receiving, from the IoT device, a result of the instruction. A first virtual object representing the IoT device may be displayed via the virtual space based on the NFT. A second virtual object representing the IoT device changed according to the result may be displayed via the virtual space.

According to an embodiment, an internet of things (IoT) server managing an IoT device may comprise communication circuitry. The IoT server may comprise memory. The IoT server may comprise a processor operatively connected to the communication circuitry and the memory. The processor may be configured to receive, from a first electronic device, a first signal including control information for the IoT device. The processor may be configured to transmit, to a blockchain network connected to the IoT server, a signal for requesting to generate a non-fungible token (NFT) including the control information for the IoT device. The method may comprise receiving, from a metaverse server managing a virtual space, a signal including an instruction to control an operation of the IoT device based on the NFT. The method may comprise transmitting, to the IoT device, the signal including the instruction. The method may comprise receiving, from the IoT device, a result of the instruction. A first virtual object representing the IoT device may be displayed via the virtual space based on the NFT. A second virtual object representing the IoT device changed according to the result may be displayed via the virtual space.

According to an embodiment, a method performed by a metaverse server managing a virtual space may comprise, based on a request of an internet of things (IoT) server managing an IoT device, receiving, from a blockchain network connected to the metaverse server, a non-fungible token (NFT) including control information for the IoT device. The method may comprise, based on receiving a request signal from a first electronic device providing the control information, displaying a first virtual object representing the IoT device via the virtual space. The method may comprise receiving, from a second electronic device obtaining the control information via the first virtual object, a signal including instruction an operation of the IoT device. The method may comprise, based on receiving the signal including the instruction, transmitting, to the IoT server, a signal requesting an operation of the IoT device. The method may comprise, based on receiving, from the IoT server, a result of the instruction, displaying a second virtual object representing the IoT device via the virtual space.

According to an embodiment, a metaverse server managing a virtual space may comprise communication circuitry. The metaverse server may comprise memory. The metaverse server may comprise a processor operatively connected to the communication circuitry and the memory. The processor may be configured to, based on a request of an internet of things (IoT) server managing an IoT device, receive, from a blockchain network connected to the metaverse server, a non-fungible token (NFT) including control information for the IoT device. The processor may be configured to, based on receiving a request signal from a first electronic device providing the control information, display a first virtual object representing the IoT device via the virtual space. The processor may be configured to receive, from a second electronic device obtaining the control information via the first virtual object, a signal including an instruction to control an operation of the IoT device. The processor may be configured to, based on receiving the signal including the instruction, transmit, to the IoT server, a signal requesting an operation of the IoT device. The processor may be configured to, based on receiving, from the IoT server, a result of the command, display a second virtual object representing the IoT device via the virtual space.

### DESCRIPTION OF THE DRAWINGS

FIG. 1 illustrates an example of an operation of controlling an electronic device via a visual object displayed based on a non-fungible token (NFT) in a virtual space according to an embodiment.

FIG. 2 illustrates an example of a block diagram of components for controlling an electronic device via a visual object displayed based on an NFT in a virtual space according to an embodiment.

FIG. 3 illustrates an example of an operation of generating an NFT related to an internet of things (IoT) device according to an embodiment.

FIG. 4 illustrates an example of a flowchart of a server for generating an NFT related to an IoT device according to an embodiment.

FIG. 5 illustrates an example of an operation of transferring ownership of an NFT according to an embodiment.

FIG. 6 illustrates an example of a web page displaying an NFT according to an embodiment.

FIG. 7 illustrates an example of an operation of controlling an electronic device via a visual object displayed based on an NFT in a virtual space according to an embodiment.

FIG. 8 illustrates an example of a flowchart of a server for controlling an electronic device via a visual object displayed based on an NFT in a virtual space according to an embodiment.

FIG. 9 illustrates an example in which a purchasable NFT is changed according to a position of a user according to an embodiment.

### MODE FOR INVENTION

Hereinafter, various embodiments of the present document will be described with reference to the accompanying drawings.

The various embodiments of the present document and terms used herein are not intended to limit the technology described in the present document to specific embodiments, and should be understood to include various modifications, equivalents, or substitutes of the corresponding embodiment. In relation to the description of the drawings, a reference numeral may be used for a similar component. A singular expression may include a plural expression unless it is clearly meant differently in the context. In the present document, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, is only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the present document may include a unit configured with hardware, software, or firmware, and may be used interchangeably with terms such as logic, logic block, component, or circuit, and the like. The module may be an integrally configured component or a minimum unit or part thereof that performs one or more functions. For example, a module may be configured with an application-specific integrated circuit (ASIC).

A term referring to an electronic device (e.g., a refrigerator, an air conditioner, a television, an air cleaner (air purifier), and the like), a term referring to a component of a device (e.g., a processor, a camera, a display, a module, communication circuitry, and the like), a term for a calculation state (e.g., a step, an operation, and a procedure), a term referring to a signal (e.g., a signal, information, data, a stream, a user input, an input, and the like), and a term referring to data (e.g., a parameter, a value, and the like) used in the following description are exemplified for convenience of explanation. Therefore, the present disclosure is not limited to terms to be described below, and another term having an equivalent technical meaning may be used.

A decentralized network may be distinguished from a centralized network in which decision making is performed by a central server. For example, the decentralized network may refer to a network in which the decision making is performed according to a consensus algorithm of nodes included in the decentralized network. A distributed ledger may refer to a ledger in which a ledger recording transaction history is distributed and stored in multiple nodes.

For example, a distributed ledger of the decentralized network may be stored in each of the nodes participating in the decentralized network. The distributed ledger included in the decentralized network may be renewed according to a consensus algorithm of the nodes included in the decentralized network.

Referring to the above description, the decentralized network having the distributed ledger may have an advantage that a centralized server is not required. Accordingly, a demand for various solutions using the decentralized network having the distributed ledger is increasing.

A smart contract is a contract that is concluded and automatically executed, and may refer to automatically concluding a contract using the decentralized network, in the present disclosure. For the smart contract, a non-fungible token (NFT) may be used. Minting generates a new NFT, and an owner of the generated NFT may freely purchase, sell, and donate without any third-party restriction. In general, an NFT is only related to digitized data in a virtual space, but may not be related to an object in the real world. Meanwhile, an IoT device may generate a control right by going via various authentication processes and may be used. Therefore, it may be difficult for another user other than the owner to perform the authentication processes and obtain the control right.

A device and a method according to an embodiment of the present disclosure propose technology for transferring a control right of an IoT device by generating an NFT based on information for controlling the IoT device and selling the generated NFT via a virtual space. Accordingly, the device and the method according to an embodiment of the present disclosure may transfer the control right of the IoT device without going through the various authentication processes via the NFT having identification power. Additionally, the device and the method according to an embodiment of the present disclosure may perform control of an IoT device corresponding to a visual object by controlling the visual object in the virtual space.

As described above, the device and the method according to an embodiment of the present disclosure may freely sell (auction), transmit, or share a control right via a virtual space regardless of an actual device (e.g., the IoT device), a manufacturer, or a contents provider. The device and the method according to an embodiment of the present disclosure may display the control right of the actual device via an NFT in the virtual space of a metaverse and the like and directly issue a command via the NFT. The device and the method according to an embodiment of the present disclosure may control it without a complicated authentication procedure for actual device ownership via the NFT. For example, in a situation in which multiple restaurants exist in a large supermarket, a specific restaurant may have a control right over an air conditioner or a few people may share the control right.

Hereinafter, in the present disclosure, a virtual object may indicate an object in a virtual space corresponding to an external object in the real world. The virtual object may also be referred to as an avatar or a visual object. For example, the virtual object may include an object in the virtual space corresponding to the electronic device. Additionally, the virtual object may include an object in the virtual space corresponding to the user.

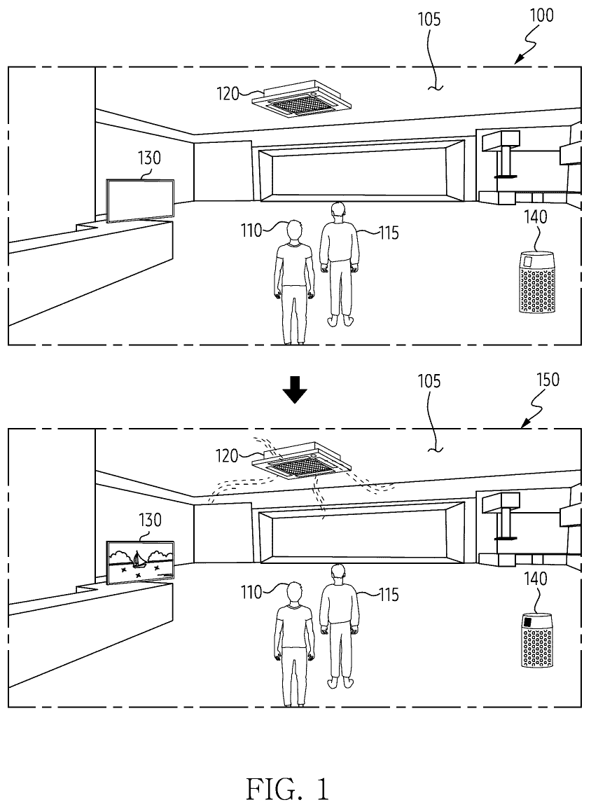

FIG. 1 illustrates an example of an operation of controlling an electronic device via a visual object displayed based on a non-fungible token (NFT) in a virtual space according to an embodiment. In an embodiment of FIG. 1, the electronic device may include an internet of things (IoT) device. FIG. 1 illustrates examples 100 and 150 of a method of controlling the electronic device in a real environment via visual objects 120, 130, and 140 in a virtual space 105.

According to an embodiment, referring to the example 100, the virtual space 105 may include the virtual objects 120, 130, and 140 corresponding to the electronic device. For example, the virtual object 120 may be a virtual object representing an air conditioner among IoT devices. The virtual object 130 may be a virtual object representing a television (TV) among IoT devices. The virtual object 140 may be a virtual object representing an air purifier among IoT devices. Each of the virtual objects 120, 130, and 140 may be generated based on a non-fungible token (NFT). For example, the NFT may be generated by minting via a blockchain network based on image information for representing a virtual object and control information on an IoT device related to the virtual object. The metaverse server providing the virtual space 105 may generate information for displaying a virtual object based on the image information on the IoT device included in the NFT. The metaverse server may transmit the information to an electronic device (e.g., a HMD, a terminal, a PC and the like) for displaying the virtual space 105. FIG. 1 illustrates the air conditioner, the TV, and air cleaners (air purifiers) as an example of the virtual objects 120, 130, and 140, but an embodiment of the present disclosure is not limited thereto.

According to an embodiment, referring to the example 100, the virtual space 105 may include virtual objects 110 and 115 corresponding to users. For example, the users may experience the virtual space 105 via the electronic device (e.g., the HMD, the terminal, the PC and the like) that is connected to the metaverse server and for displaying the virtual space 105. In other words, the electronic device may display the virtual space 105 via an output device (e.g., a display). The virtual objects 110 and 115 may be a virtual object representing the users using the electronic device by being connected to the metaverse server via the electronic device and accessing the virtual space 105. A user of the virtual object 110 may be different from a user of the virtual object 115. FIG. 1 illustrates only the virtual objects 110 and 115, but an embodiment of the present disclosure is not limited thereto. The virtual space 105 may include the larger or smaller number of virtual objects. Additionally, in FIG. 1, the virtual space 105 represented from a third-person perspective is illustrated, but an embodiment of the present disclosure is not limited thereto. The virtual space 105 may be represented from a first-person perspective, centered on a virtual object corresponding to a specific user.

In an embodiment, the users may control the virtual objects 120, 130, and 140 via the virtual space 105. For example, the users may obtain authority (hereinafter, a control right) to control the virtual objects 120, 130, and 140 via the virtual space 105 representing the virtual objects 110 and 115, and the virtual objects 120, 130, and 140. The control right may enable the virtual objects 120, 130, and 140 to be identified based on the NFT. According to a transfer of the NFT, the control right may be transferred between the users. For example, the users corresponding to the virtual objects 110 and 115 may purchase a control right over the virtual objects 120, 130, and 140 via the virtual space 105.

According to an embodiment, referring to an example 150, the users who purchase the control right may control the virtual objects 120, 130, and 140 via the virtual space 105. Unlike the virtual objects 120, 130, and 140 of the example 100, the virtual objects 120, 130, and 140 of the example 150 may each be displayed in a powered-on and driven state. In case that the virtual object is displayed in a powered-on state, such as the virtual objects 120, 130, and 140 of the example 150, the metaverse server may request to control the IoT devices by performing communication with an IoT server connected to the IoT devices corresponding to the virtual objects 120, 130, and 140. Accordingly, in case that the virtual objects 120, 130, and 140 are controlled in the virtual space 105, actual IoT devices corresponding to the virtual objects 120, 130, and 140 may also be controlled substantially identically.

The metaverse is a compound word of the English words “Meta” meaning “virtual” and “transcendence” and “Universe” meaning space, and indicates a three-dimensional virtual world in which social, economic, and cultural activities such as the real world are performed. The metaverse is a concept one step more advanced than a virtual reality (VR, state-of-the-art technology that enables people to have a real-life-like experience in a computer-generated virtual world), and is characterized by not only enjoying a game or the virtual reality using an avatar, but also enabling social and cultural activities like real life. A metaverse service may provide media content to enhance immersion in the virtual world based on an augmented reality (AR), a virtual reality environment (VR), a mixed reality environment (MR), and/or an extended reality (XR).

For example, the media content provided by the metaverse service may include social interaction content, including an avatar-based game, concert, party, and/or meeting. For example, the media content may include information for an economic activity such as advertising, selling user created content and/or production, and/or shopping. Ownership of the user created content may be proved by a blockchain-based non-fungible token (NFT). The metaverse service may support an economic activity based on real money and/or cryptocurrency. Virtual content related to the real world, such as a digital twin or life logging, may be provided by the metaverse service.

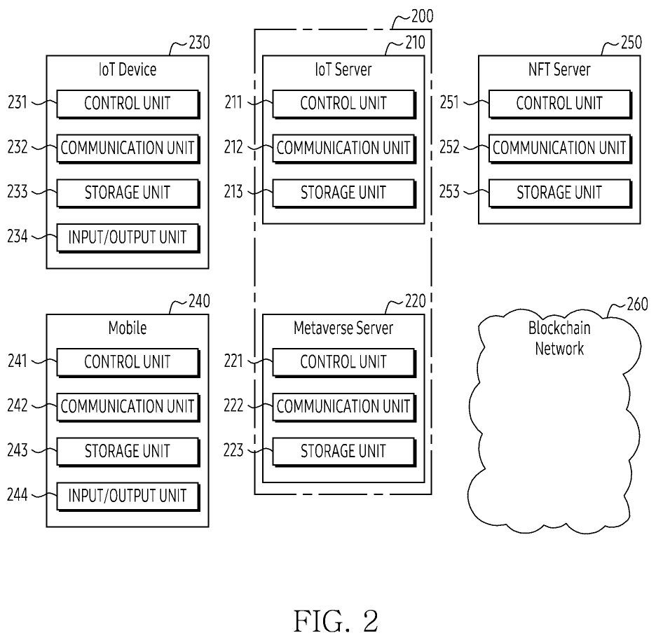

FIG. 2 illustrates an example of a block diagram of components for controlling an electronic device via a visual object displayed based on an NFT in a virtual space according to an embodiment. An IoT server 210, a metaverse server 220, an NFT server 250 of FIG. 2 may be understood as including a virtual server itself and a device that operates a server.

According to an embodiment, the IoT server 210 may include a control unit 211, a communication unit 212, and a storage unit 213. The control unit 211, the communication unit 212, and the storage unit 213 may be electronically and/or operably coupled with each other by an electronical component. Hereinafter, hardware being operably coupled may mean that a direct connection or an indirect connection between the hardware is established by wire or wirelessly, so that second hardware among the hardware is controlled by first hardware. Although illustrated based on different blocks, an embodiment is not limited thereto, and a portion (e.g., a processor of the control unit 211, at least a portion of communication circuitry of the communication unit 212, and memory of the storage unit 213) of the hardware of FIG. 2 may be included in a single integrated circuit such as a system on a chip (SoC).

In an embodiment, the control unit 211 of the IoT server 210 may include hardware for processing data based on one or more instructions. The hardware for processing data may include, for example, an arithmetic and logic unit (ALU), a floating point unit (FPU), a field programmable gate array (FPGA), a central processing unit (CPU), and/or an application processor (AP). For example, the control unit 211 may include at least one processor. The at least one processor may have a structure of a single-core processor, or may have a structure of a multi-core processor such as a dual core, a quad core, or a hexa core.

In an embodiment, the communication circuitry of the communication unit 212 may include a hardware component for supporting transmission and/or reception of an electrical signal between the IoT server 210 and an external electronic device (e.g., an IoT device) or another server device. The communication circuitry may include, for example, at least one of a MODEM, an antenna, and an optic/electronic (O/E) converter. The communication circuitry may support the transmission and/or the reception of the electrical signal based on various types of protocols such as ethernet, a local area network (LAN), a wide area network (WAN), wireless fidelity (WiFi), Bluetooth, bluetooth low energy (BLE), ZigBee, long term evolution (LTE), a 5G new radio (NR), and/or 6G. The communication circuitry may be referred to as a transceiver.

In an embodiment, the storage unit 213 of the IoT server 210 may include a hardware component for storing data and/or an instruction inputted and/or outputted to the control unit 211. The storage unit 213 may include memory. The memory may include, for example, volatile memory such as random-access memory (RAM) and/or non-volatile memory such as read-only memory (ROM). The volatile memory may include, for example, at least one of dynamic RAM (DRAM), static RAM (SRAM), Cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disk, a solid state drive, and an embedded multi media card (eMMC).

Referring to an embodiment of FIG. 2, in the memory of the IoT server 210, one or more instructions (or commands) indicating a calculation and/or an operation to be performed by the at least one processor of the IoT server 210 on data may be stored. A set of one or more instructions may be referred to as a firmware, an operating system, a process, a routine, a sub-routine and/or an application. Hereinafter, an application being installed in the electronic device (e.g., the IoT server 210 or a device that operates the IoT server 210) may mean that one or more instructions provided in a form of an application are stored in the memory, and that the one or more applications are stored in a format (e.g., a file having an extension designated by the operating system) executable by the processor of the electronic device.

As described above, a description of the IoT server 210 may be identically applied to each of the metaverse server 220 and the NFT server 250. For example, each description of the control unit 211, the communication unit 212, and the storage unit 213 of the IoT server 210 may be substantially identically understood as each description of a control unit 221, a communication unit 222, and a storage unit 223 of the metaverse server 220. Additionally, for example, each description of the control unit 211, the communication unit 212, and the storage unit 213 of the IoT server 210 may be substantially identical to each description of a control unit 251, a communication unit 252, and a storage unit 253 of the NFT server 250.

Referring to FIG. 2, an IoT device 230 may include a control unit 231, a communication unit 232, a storage unit 233, and an input/output unit 234. A description of each of the control unit 231, the communication unit 232, and the storage unit 233 of the IoT device 230 may be understood as substantially identical to the control unit 211, the communication unit 212, and the storage unit 213 of the IoT server 210. In an embodiment, the input/output unit 234 may include at least one sensor for identifying an input including a touch input, a motion input, and a gesture to a display of a user. The at least one sensor may generate electronic information that may be processed by a processor and/or memory of the IoT device 230 from non-electronic information related to the IoT device 230 used by the user. The information may be referred to as sensor data. The at least one sensor may include a global positioning system (GPS) sensor for detecting a geographic location of the IoT device 230, an image sensor, an illumination sensor and/or a time-of-flight (ToF) sensor, and an inertial measurement unit (IMU) for detecting a physical motion. In an embodiment, the input/output unit 234 may include a display for performing an operation and outputting a performed result based on information provided from the IoT server 210. For example, the display may output visualized information to the user by being controlled by a processor including circuitry such as a graphic processing unit (GPU). The display may include a flat panel display (FPD) and/or electronic paper. The FPD may include a liquid crystal display (LCD), a plasma display panel (PDP), and/or one or more light emitting diodes (LEDs). The LED may include an organic LED (OLED).

Referring to FIG. 2, an electronic device 240 may indicate an electronic device that is connected to the metaverse server 220 and forms and outputs a virtual space based on information received from the metaverse server 220. The electronic device 240 may include a control unit 241, a communication unit 242, a storage unit 243, and an input/output unit 244. A description of each of the control unit 241, the communication unit 242, and the storage unit 243 of the electronic device 240 may be understood as substantially identical to the control unit 211, the communication unit 212, and the storage unit 213 of the IoT server 210. A description of the input/output unit 244 of the electronic device 240 may be understood as substantially identical to the input/output unit 234 of the IoT device 230. For example, the input/output unit 244 of the electronic device 240 may include at least one sensor for identifying an input including a touch input, motion input, and gesture to the display of the user. Additionally, the input/output unit 244 of the electronic device 240 may include a display for forming a virtual space and outputting the formed virtual space based on information provided from the metaverse server 220.

In an embodiment, the IoT server 210 and the metaverse server 220 may be configured via one server 200. For example, the server 200 may be connected to the IoT device 230 and may also be connected to the electronic device 240. The server 200 may perform a control operation for managing the IoT device 230, and may transmit information for managing a metaverse server and forming a virtual space to the electronic device 240.

In an embodiment, a blockchain network 260 may include a plurality of nodes. For example, the blockchain network 260 may include a full node in which an entire blockchain is stored and a light node in which only a portion of the blockchain is stored. The blockchain network 260 may be connected to the IoT server 210, the metaverse server 220, or the electronic device 240. The blockchain network 260 may mint an NFT based on a request from the IoT server 210, the metaverse server 220, or the electronic device 240.

Referring to the description above, a device and a method according to an embodiment of the present disclosure may request that an electronic device (e.g., the electronic device 240) generates an NFT based on information on an IoT device (e.g., the IoT device 230). The electronic device may transfer a control right of the IoT device by displaying the generated NFT via a metaverse server and selling the NFT to a user of another electronic device (e.g., the electronic device 240). The user of the other electronic device may control the IoT device by using the control right transferred via the purchased NFT.

In an embodiment, the electronic device may request to generate the NFT based on information on the IoT device and information on a user of the IoT device. For example, the electronic device may request the blockchain network to generate the NFT via an IoT server connected to the IoT device. For example, the electronic device may request the blockchain network to generate the NFT via a metaverse server connected to the electronic device. For example, the electronic device may directly request the blockchain network to generate the NFT. For convenience of explanation, the following is described based on an example in which the electronic device requests the blockchain network to generate the NFT via the IoT server.

In an embodiment, the request to generate the NFT may include information for NFT minting. For example, the information may include image information (e.g., a 2 dimensional (D), a 3D) representing the IoT device. The information may include a range of authority capable of controlling the IoT device and a function (e.g., a temperature control, an air volume control and the like, in case that the IoT device is an air conditioner) included in the authority capable of controlling. The information may include a period when the IoT device is capable of being controlled. The information may include product information (e.g., a type, and a product number) of the IoT device. The information may include a fee for purchasing the authority capable of controlling the IoT device. The information may include renewal information (e.g., a due date, the number of renewals, and a renewal fee) of the authority capable of controlling the IoT device. The information may include position information of the IoT device. For example, at least a portion of the information may be encrypted in a private state via contents locking in a process of generating (or minting) the NFT. At least a portion of the information may be referred to as control information for controlling the IoT device.

In an embodiment, the IoT server may transmit information for minting the NFT to the blockchain network based on a generation request of the received NFT.

In an embodiment, the IoT server may receive the generated NFT from the blockchain network. The IoT server may transmit the received NFT to the electronic device.

In an embodiment, the electronic device may transmit the received NFT to the metaverse server. For example, in case that the user of the electronic device intends to sell the NFT, the user may request the metaverse server to transmit and display information on the NFT. Additionally, the electronic device may transmit the information on the NFT to an NFT server. The NFT server may be a server that manages a transfer (sale and purchase) of the NFT. The NFT server may be connected to the metaverse server to transfer the NFT. The NFT server may be referred to as an NFT market server.

In an embodiment, the metaverse server may display a virtual object based on information on the received NFT. The virtual object may be generated based on image information on the IoT device included in the NFT. For example, the virtual object may be a virtual object representing the IoT device. In an embodiment, in case of identifying an input to the virtual object, the metaverse server may generate information for displaying another virtual object for displaying information (e.g., control authority, IoT device information, and the like) included in the NFT. The metaverse server may transmit the information for displaying the other virtual object to a specific electronic device in which the input is identified.

In an embodiment, the metaverse server may identify a purchase request from another electronic device different from the electronic device. For example, the other electronic device may indicate an electronic device used by another user different from the user of the electronic device. In case of identifying the purchase request, the metaverse server may notify the NFT server and the electronic device that requested display to sell the NFT. In case that the purchase is completed via a legitimate procedure, the NFT server may transmit information on the NFT to the other electronic device that has transmitted the purchase request.

In an embodiment, the other electronic device may request the metaverse server to control the IoT device based on the information on the NFT. For example, the other electronic device may transmit a signal including the information on the NFT to the metaverse server. For example, the other electronic device may transmit the signal to the metaverse server based on user input information on the other electronic device. For example, the user input information may include information indicating an input by a user or an external object identified by the other electronic device. The signal may include the information on the NFT and command information for controlling an operation of the IoT device.

In an embodiment, the metaverse server may transmit the information on the NFT and the command information for controlling the operation of the IoT device to the IoT server that manages the IoT device. The IoT server may identify whether control authority for the IoT device exists by comparing information on the NFT received from the metaverse server with information on the minted NFT, via the blockchain network. In case of identifying that the control authority exists, the IoT server may transmit a control signal to the IoT device. The control signal may include information for instructing the IoT server to perform an identified operation based on the command information.

In an embodiment, the IoT server may receive a result of the command from the IoT device. The IoT server may transmit the result of the command to the metaverse server. The metaverse server may change and display the virtual object corresponding to the IoT device based on the received result of the command. For example, in case that the IoT device is powered off and then powered on according to the command, the metaverse server may change and display the virtual object corresponding to the IoT device in a powered-on state. The change and display may indicate that the metaverse server generates information on the virtual object so that the virtual object may be displayed in a changed state.

In an embodiment, the metaverse server may transmit information on the virtual object for displaying the changed state to the other electronic device. The other electronic device may display the virtual object in the changed state and the virtual space including the virtual object based on the received information.

As described above, a device and a method according to an embodiment of the present disclosure propose technology for transferring a control right of an IoT device by generating an NFT based on information for controlling the IoT device and selling the generated NFT via a virtual space. Accordingly, the device and the method according to an embodiment of the present disclosure may transfer the control right of the IoT device without going through the various authentication processes via the NFT having identification power. Additionally, the device and the method according to an embodiment of the present disclosure may perform control of an IoT device corresponding to a visual object by controlling the visual object in the virtual space.

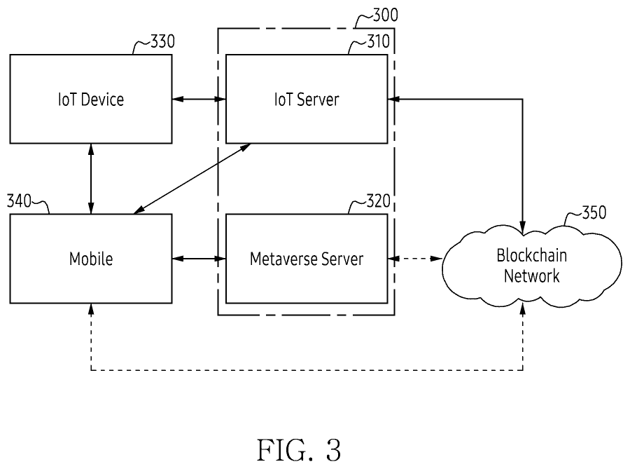

FIG. 3 illustrates an example of an operation of generating an NFT related to an internet of things (IoT) device according to an embodiment. An IoT server 310 of FIG. 3 may be understood as substantially identical to the IoT server 210 of FIG. 2. A metaverse server 320 of FIG. 3 may be understood as substantially identical to the metaverse server 220 of FIG. 2. An IoT device 330 of FIG. 3 may be understood as substantially identical to the IoT device 230 of FIG. 2. An electronic device 340 of FIG. 3 may be understood as substantially identical to the electronic device 240 of FIG. 2. A blockchain network 350 of FIG. 3 may be understood as substantially identical to the blockchain network 260 of FIG. 2.

An example of FIG. 3 illustrates an example of requesting a generation of an NFT based on information on the IoT device 330 according to a request of the electronic device 340. In FIG. 3, a state in which the blockchain network 350 is connected to the IoT server 310 is described as an example, but an embodiment of the present disclosure is not limited thereto. For example, the blockchain network 350 may also be connected to the electronic device 340 or the metaverse server 320. Additionally, in FIG. 3, the IoT server 310 and the metaverse server 320 are illustrated as separate servers, but may be configured as one server 300.

In an embodiment, the electronic device 340 may be connected to the IoT device 330. For example, the electronic device 340 may obtain information on the IoT device 330. The information on the IoT device 330 may include a product number of the IoT device 330 and a product type of the IoT device 330.

In an embodiment, the electronic device 340 may be connected to the IoT server 310. The electronic device 340 connected to the IoT server 310 may control the IoT device 330 via the IoT server 310 based on the information on the IoT device 330.

In an embodiment, the IoT server 310 may be connected to the IoT device 330. The IoT server 310 may be connected to at least one IoT device including the IoT device 330.

In an embodiment, the electronic device 340 may transmit a signal requesting to generate an NFT. For example, the electronic device 340 may transmit the signal for an NFT generation request to the blockchain network 350 via the IoT server 310. However, an embodiment of the present disclosure is not limited thereto. The electronic device 340 may directly transmit a request for generating the NFT to the blockchain network 350. Alternatively, the electronic device 340 may transmit the request for generating the NFT to the blockchain network 350 via the metaverse server 320.

In an embodiment, the request for generating the NFT may include information for NFT minting. For example, the information for the NFT minting may include image information (e.g., a 2 dimensional (D), a 3D) representing the IoT device. The information for the NFT minting may include control information for the IoT device. The control information may include a range of authority capable of controlling the IoT device and a function (e.g., a temperature control, an air volume control and the like, in case that the IoT device is an air conditioner) included in the authority capable of controlling. The control information may include a period when the IoT device is capable of being controlled. The control information may include product information (e.g., a type, and a product number) of the IoT device. The control information may include a fee for purchasing the authority capable of controlling the IoT device. The control information may include renewal information (e.g., a due date, the number of renewals, and a renewal fee) of the authority capable of controlling the IoT device. The control information may include position information of the IoT device. For example, at least a portion of the control information may be encrypted in a private state via contents locking in a process of generating (or minting) the NFT. At least a portion of the information may be referred to as the control information for the IoT device.

In an embodiment, the IoT server 310 may transmit the signal requesting the NFT generation to the blockchain network 350. The signal requesting the NFT generation may include the information for the NFT minting.

In an embodiment, the IoT server 310 may receive the generated NFT from the blockchain network 350. For example, the IoT server 310 may receive the NFT including information on the IoT device 330 and information for identifying the NFT from the blockchain network 350. The information for identifying the NFT may include an identity indicating the NFT.

In an embodiment, the NFT and the information for identifying the NFT may be transmitted from the blockchain network 350 to the electronic device 340 via the metaverse server 320 according to a path through which the request for generating the NFT is delivered or may be transmitted directly to the electronic device 340.

In an embodiment, the IoT server 310 may transmit the received NFT and the information for identifying the NFT to the electronic device 340.

In an embodiment, the electronic device 340 may request the metaverse server 320 to display the NFT in a virtual space provided by the metaverse server 320. For example, the electronic device 340 may request to display a virtual object generated based on the image information representing the IoT device 330 (or a shape of the IoT device 330) included in the NFT in the virtual space. This may be to sell the NFT via the virtual space. In an embodiment, the metaverse server 320 may identify whether the electronic device 340 may request a display for the NFT via a blockchain related to the NFT in response to the received request.

In an embodiment, in case of identifying the NFT as displayable, the metaverse server 320 may generate information to represent the virtual object representing the IoT device 330 included in the NFT. For example, the metaverse server 320 may generate the information for representing the virtual object as 2D image information. For example, the metaverse server 320 may generate the information for representing the virtual object as 3D image information. In an embodiment, the metaverse server 320 may display the virtual object in the virtual space. For example, the metaverse server 320 may transmit the information for representing the virtual object to the electronic device 340. Accordingly, the electronic device 340 may display the virtual space including the virtual object via an output device.

In an embodiment, the metaverse server 320 may notify the IoT server 310 in case that the virtual object representing the IoT device 330 is displayed (or exhibited) in the virtual space.

In FIG. 3, for convenience of explanation, the IoT server 310 and the metaverse server 320 are described to operate as separate servers, but an embodiment of the present disclosure is not limited thereto. For example, an embodiment of the present disclosure may include a case in which the IoT server 310 and the metaverse server 320 perform operations performed by the IoT server 310 and the metaverse server 320 as the one server 300.

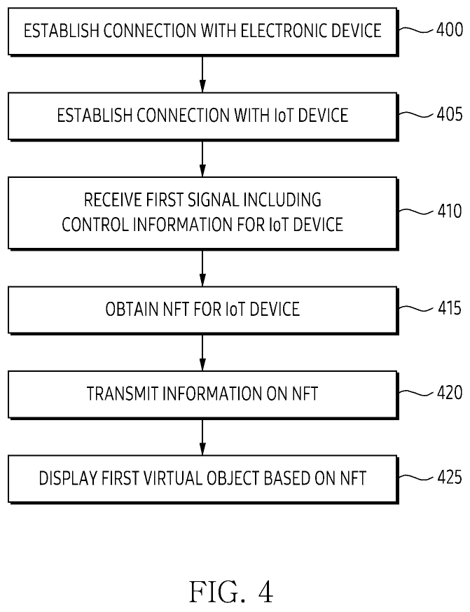

FIG. 4 illustrates an example of a flowchart of a server for generating an NFT related to an IoT device according to an embodiment. In an embodiment of FIG. 4, the server may include the server 200 of FIG. 2 and the server 300 of FIG. 3. The server may include an IoT server (e.g., the IoT server 210 of FIG. 2, the IoT server 310 of FIG. 3, and a metaverse server (e.g., the metaverse server 220 of FIG. 2 and the metaverse server 320 of FIG. 3)).

In FIG. 4, although illustrated based on an operation of the server, an embodiment of the present disclosure is not limited thereto. An embodiment of the present disclosure may include an operation of the IoT server or an operation of the metaverse server included in the server.

According to an embodiment, in an operation 400, the server may establish a connection with an electronic device. For example, the server may establish a connection with the electronic device (e.g., the electronic device 240 of FIG. 2) that displays a virtual space provided by the metaverse server. For example, each of the IoT server and the metaverse server included in the server may establish a connection with the electronic device.

According to an embodiment, in an operation 405, the server may establish a connection with the IoT device. For example, the IoT device may be related to the electronic device. For example, the IoT device may include an IoT device that has established a connection with the electronic device. For example, the IoT server included in the server may establish a connection with the IoT device. The IoT device may include at least one IoT device.

According to an embodiment, in an operation 410, the server may receive a first signal including control information for the IoT device. For example, the server may receive the first signal including the control information of the IoT device from the electronic device. The control information of the IoT device may be included in information for non-fungible token (NFT) minting. For example, the first signal may include the information for the NFT minting. For example, the information for the NFT minting may include image information (e.g., a 2 dimensional (D), a 3D) representing the IoT device. For example, the information for the NFT minting may include the control information for the IoT device. The control information may include a range of authority capable of controlling the IoT device and a function (e.g., a temperature control, an air volume control and the like, in case that the IoT device is an air conditioner) included in the authority capable of controlling. The control information may include a period when the IoT device is capable of being controlled. The control information may include product information (e.g., a type, and a product number) of the IoT device. The control information may include a fee for purchasing the authority capable of controlling the IoT device. The control information may include renewal information (e.g., a due date, the number of renewals, and a renewal fee) of the authority capable of controlling the IoT device. The control information may include position information of the IoT device. For example, at least a portion of the control information may be encrypted in a private state via contents locking in a process of generating (or minting) the NFT. The first signal may be referred to as a signal for requesting to generate the NFT. For example, the IoT server included in the server may receive the first signal from the electronic device. Alternatively, the metaverse server included in the server may receive the first signal from the electronic device. In case that the electronic device directly transmits the control information of the IoT device to a blockchain network, the operation 410 may be omitted.

According to an embodiment, in an operation 415, the server may obtain an NFT for the IoT device. For example, the server may request a generation of the NFT for the IoT device by transmitting the first signal received from the electronic device to the blockchain network connected to the server. In response, the server may receive the NFT for the IoT device and identification information for identifying the NFT from the blockchain network. For example, the IoT server included in the server may receive the NFT and the identification information for identifying the NFT. Alternatively, the metaverse server included in the server may receive the NFT and the identification information for identifying the NFT. In case that the electronic device directly transmits the control information of the IoT device to the blockchain network, the operation 415 may be omitted.

According to an embodiment, in an operation 420, the server may transmit information on an NFT to the electronic device. For example, the server may transmit the NFT and the identification information for identifying the NFT to the electronic device. In a case that the electronic device directly transmits the control information of the IoT device to the blockchain network, the operation 420 may be omitted.

According to an embodiment, in an operation 425, the server may display a first virtual object based on the NFT. For example, the server may display the first virtual object based on the NFT, in case of receiving a signal requesting to display the NFT from the electronic device. For example, the first virtual object may be generated based on the image information representing the IoT device included in the NFT. For example, the metaverse server included in the server may display the first virtual object in response to receiving the signal requesting to display the NFT from the electronic device. Although not illustrated in FIG. 4, the electronic device may transmit the signal requesting to display the NFT to the server (or the metaverse server) and, at the same time, transmit the information on the NFT to the NFT server together. The NFT server may be a server that is connected to the server (or the metaverse server) and manages (e.g., sale and purchase) the NFT.

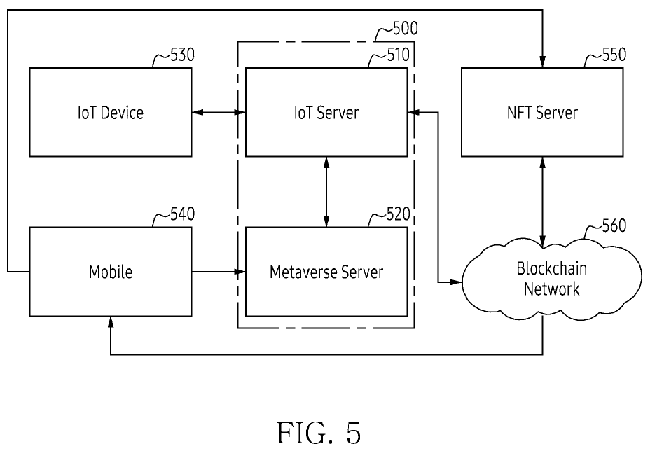

FIG. 5 illustrates an example of an operation of transferring ownership of an NFT according to an embodiment. An IoT server 510 of FIG. 5 may be understood as substantially identical to the IoT server 210 of FIG. 2. A metaverse server 520 of FIG. 5 may be understood as substantially identical to the metaverse server 220 of FIG. 2. An IoT device 530 of FIG. 5 may be understood as substantially identical to the IoT device 230 of FIG. 2. An electronic device 540 of FIG. 5 may be understood as substantially identical to the electronic device 240 of FIG. 2. However, unlike the electronic device 240 of FIG. 2 that requests a generation of an NFT and sells it, the electronic device 540 of FIG. 5 may be an electronic device (e.g., the other electronic device of FIG. 2) that performs a purchase of the NFT. Therefore, hereinafter, for convenience of explanation, the electronic device 540 is referred to as another electronic device 540. An NFT server 550 of FIG. 5 may be understood as substantially identical to the NFT server 250 of FIG. 2. A blockchain network 560 of FIG. 5 may be understood as substantially identical to the blockchain network 260 of FIG. 2.

An example of FIG. 5 illustrates an example of the other electronic device 540 transferring ownership of an NFT via a virtual object in a virtual space provided by the metaverse server 520. The transfer of the ownership of the NFT may be understood as transferring a control right of the IoT. In FIG. 5, a state in which the blockchain network 560 is connected to the IoT server 510 is described as an example, but an embodiment of the present disclosure is not limited thereto. For example, the blockchain network 560 may also be connected to the other electronic device 540 or the metaverse server 520. In addition, in FIG. 5, the IoT server 510 and the metaverse server 520 are illustrated as separate servers, but may be configured as one server 500.

In an embodiment, the other electronic device 540 may request a purchase of the NFT displayed via the virtual object in the virtual space provided by the metaverse server 520. For example, a user of the other electronic device 540 may identify a shape or an image of the NFT displayed via the virtual object. The user may perform an input to the virtual object displayed via a display of the other electronic device 540. Accordingly, the other electronic device 540 may display another virtual object for displaying information (e.g., control authority, IoT device information and the like) of the NFT. The user may determine to purchase the NFT based on the virtual object and the other virtual object. The other electronic device 540 may directly transmit a signal for a purchase request of the NFT to the NFT server 550. In an embodiment, the other electronic device 540 may transmit the signal for the purchase request of the NFT via the metaverse server 520. The metaverse server 520 may deliver the request signal to the connected NFT server 550.

According to an embodiment, the NFT server 550 may request to transfer the ownership of the NFT to the other electronic device 540 via the blockchain network 560 in response to the request signal. For example, the NFT server 550 may transmit a request signal for the transfer of the ownership of the NFT to the blockchain network 560, and in response, the blockchain network 560 may deliver the ownership (or information on the NFT) of the NFT to the other electronic device 540.

According to an embodiment, in case that the ownership of the NFT is obtained, the other electronic device 540 may notify the metaverse server 520 of obtaining the ownership of the NFT corresponding to the virtual object. For example, the other electronic device 540 may transmit a signal to the metaverse server 520 to notify that the ownership of the NFT is obtained. In an embodiment, the metaverse server 520 may display a virtual object for displaying that the virtual object has been transferred based on the received signal. For example, together with the virtual object, a virtual object indicating the ownership may be displayed. In an embodiment, in case that the ownership of the NFT has been transferred, the metaverse server 520 may notify the IoT server 510 that the ownership of the NFT has been changed.

In an embodiment, in case of identifying that the ownership of the NFT is changed, the IoT server 510 may identify that the ownership of the NFT has been legitimately transferred via the blockchain network 560. If it is identified that the ownership of the NFT has been legitimately transferred, the IoT server 510 may transmit a result indicating that the ownership of the NFT is transferred from an electronic device (not illustrated) (e.g., the electronic device 340 of FIG. 3) to the other electronic device 540 to the IoT device 530 and the metaverse server 520 related to the NFT.

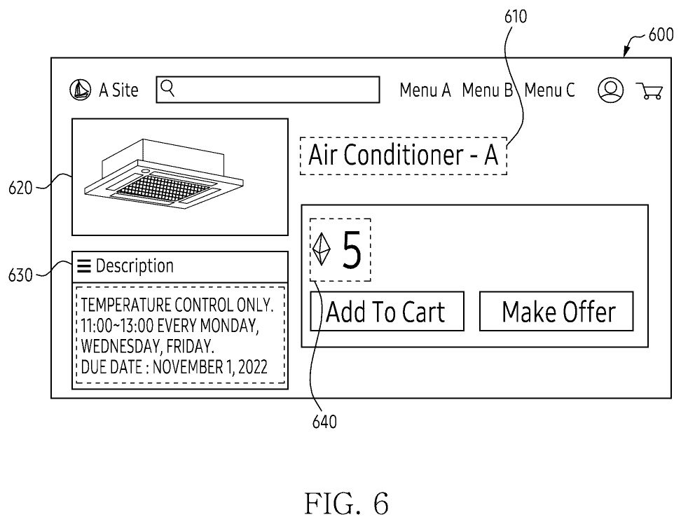

FIG. 6 illustrates an example of a web page displaying an NFT according to an embodiment. The web page may indicate an example for transferring ownership of the NFT displayed via an NFT server (e.g., the NFT server 250 of FIG. 2 and the NFT server 550 of FIG. 5).

Referring to FIG. 6, an NFT server (not illustrated) may display a user interface 600 via a web page. For example, the user interface 600 may be displayed in a data network connected to an electronic device (e.g., the electronic device 240 of FIG. 2 and the electronic device 340 of FIG. 3) and another electronic device (e.g., the other electronic device 540 of FIG. 5). The NFT server may be included in the data network.

In an embodiment, the user interface 600 may include visual objects for displaying information of the NFT. For example, the user interface 600 may include a visual object 620 that displays a shape of an IoT device related to the NFT. For example, the user interface 600 may display visual objects 610, 630, and 640 for displaying control information of the IoT device. For example, the visual object 610 may display a product type of the IoT device. The product type of the IoT device may be an air conditioner. The visual object 630 may display control authority of the IoT device. For example, the control authority may include a range and a function of a control right, and a period and a due date of the control right. The range and the function of the control right may only provide a temperature control. The period of the control right may include a time between 11:00 to 13:00 and a date on Monday, Wednesday and Friday of each week. The due date may be Nov. 1, 2022. The visual object 640 may include fee information for indicating a fee for purchasing the NFT.

The information of the NFT may not be limited to information displayed via the user interface 600 of FIG. 6. For example, the information of the NFT may include information such as the following table.

TABLE 1

| | | Available | Available | | | | Secondary |
|---|---|---|---|---|---|---|---|
| NFT | Authority | hours | days | Due date | Device | Amount | fee |
| NFT#1 | Control | 11:00~13:00 | Monday, | Nov. 1, | Air | 2 Eth | 1% |
| | (temperature) | | Wednesday, | 2022 | Conditioner- | | |
| | | | Friday | | A | | |
| NFT#2 | Control, | 11:00~15:00 | Tuesday, | Nov. 1, | Air | 5 Eth | 5% |
| | share | | Thursday | 2022 | Conditioner- | | |
| | (5 people) | | | | A | | |
| NFT#3 | Control | 08:00~17:00 | Friday | Nov. 5, | Air | 7 Eth | 3% |
| | (power) | | | 2022 | Conditioner- | | |
| | | | | | B | | |
| NFT#4 | Control | 08:00~17:00 | Wednesday | Nov. 29, | Air | 6 Eth | 4% |
| | (entire) | | | 2022 | Conditioner- | | |
| | | | | | B | | |
| NFT#5 | Control, | 08:00~17:00 | Wednesday, | Permanent | Air | 17 Eth | 2% |
| | share | | Thursday | | Conditioner- | | |
| | (2 people) | | | | C | | |
| NFT#6 | Share (1 | 17:00~23:00 | Saturday, | Nov. 6, | CCTV-A | 3 Eth | 1% |
| | third party) | | Sunday | 2022 | | | |
| NFT#7 | Share (1 | 21:00~23:00 | Friday, | Dec 7, | CCTV-A | 4 Eth | 3% |
| | third party) | | Saturday, | 2022 | | | |
| | | | Sunday | | | | |
| NFT#8 | Control | 21:00~23:00 | Friday, | Dec 8, | CCTV-B | 8 Eth | 5% |
| | (power) | | Saturday, | 2023 | | | |
| | | | Sunday | | | | |

The NFT # may indicate identification information for identifying an NFT. The authority may indicate control authority and a function of the IoT included in the NFT. The available time, the available days, and the due date may indicate a control period of the IoT included in the NFT. The device may indicate product information of the IoT. The amount may indicate a fee required to purchase the NFT. The secondary fee may indicate a fee received by a person who first requested minting the NFT in case that a person who purchased the NFT sells it again.

In an embodiment, in addition to information of the table, information of the NFT may include renewal information on the NFT. For example, the renewal information may include a due date by which the NFT may be renewed, the number of times the NFT may be renewed, the number of times the NFT has been renewed, and a fee required to renew the NFT.

In an embodiment, the information of the NFT may include a product number of the IoT device related to the NFT. In an embodiment, the information of the NFT may include position information of the IoT device related to the NFT.

Referring to FIG. 6, as the information of the NFT displayed via the user interface 600 does not include all information, in an embodiment, at least a portion of the information of the NFT may be included in the NFT in a private state, in case that the NFT is minted. The private state may indicate that it is displayed only to a person who has ownership of the NFT. For example, when the NFT is first minted, the at least a portion may be included in the NFT in the private state via contents locking.

In FIG. 6, the user interface 600 that displays the visual object 620 for the shape displaying the IoT device and the visual objects 610, 630, and 640 for displaying the control information together is illustrated, but an embodiment of the present disclosure is not limited thereto. For example, the user interface 600 may display the visual object 620 first and in case that an input to the visual object 620 is identified, may display the visual objects 610, 630, and 640 together.

Referring to FIG. 6, the user interface 600 indicating the web page is displayed as a 2D image on the web page provided by an NFT server (e.g., the NFT server 250 of FIG. 2 and the NFT server 550 of FIG. 5), but an embodiment of the present disclosure is not limited thereto. For example, the web page may be displayed in a virtual space, which is a three-dimensional space provided by a metaverse server, via a virtual object that is substantially identical to the user interface 600 provided by the NFT server. For example, the user interface 600 may be formed in a form of an exhibition hall as in the example 100 of FIG. 1. In response to at least a portion of an input for the virtual objects 120, 130, and 140 of the example 100, virtual objects corresponding to visual objects (e.g., the visual objects 610, 630, and 640) for displaying control information of an IoT device corresponding to the virtual objects 120, 130, and 140 may be displayed via the virtual space.

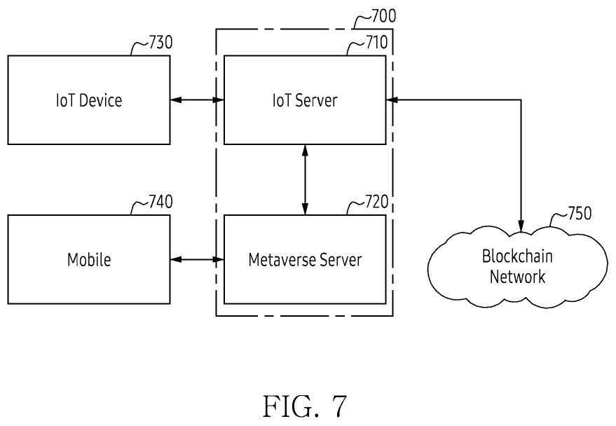

FIG. 7 illustrates an example of an operation of controlling an electronic device via a visual object displayed based on an NFT in a virtual space according to an embodiment. An IoT server 710 of FIG. 7 may be understood as substantially identical to the IoT server 210 of FIG. 2. A metaverse server 720 of FIG. 7 may be understood as substantially identical to the metaverse server 220 of FIG. 2. An IoT device 730 of FIG. 7 may be understood as substantially identical to the IoT device 230 of FIG. 2. An electronic device 740 of FIG. 7 may be understood as substantially identical to the electronic device 240 of FIG. 2. However, unlike the electronic device 340 of FIG. 3 that requests a generation of an NFT and sells it, the electronic device 740 of FIG. 7 may be an electronic device (e.g., the other electronic device of FIG. 2, and the other electronic device 540 of FIG. 5) that purchases the NFT. Therefore, hereinafter, for convenience of explanation, the electronic device 740 is referred to as another electronic device 740. A blockchain network 750 of FIG. 7 may be understood as substantially identical to the blockchain network 260 of FIG. 2.

An example of FIG. 7 illustrates an example of controlling the IoT device 730 based on an NFT according to a request of the other electronic device 740. In FIG. 7, a state in which the blockchain network 750 is connected to the IoT server 710 is described as an example, but an embodiment of the present disclosure is not limited thereto. For example, the blockchain network 750 may also be connected to the other electronic device 740 or the metaverse server 720. Additionally, in FIG. 3, the IoT server 710 and the metaverse server 720 are illustrated as separate servers, but may be configured as one server 700.

According to an embodiment, the other electronic device 740 may obtain the NFT from an electronic device (not illustrated) (e.g., the electronic device 340 of FIG. 3) and then transmit a signal for a control request of the IoT device 730 to the metaverse server 720. For example, the other electronic device 740 may request control of the IoT device 730 via a virtual object displaying the NFT in a virtual space provided by the metaverse server 720. In an embodiment, the other electronic device 740 may identify an input for the virtual object and identify user input information on the identified input. In an embodiment, the other electronic device 740 may transmit the signal for the control request including command information for controlling an operation of the IoT device 730 to the metaverse server 720 based on the user input information. The input may include a touch input, a motion input, and a gesture of a user of the other electronic device 740.

In an embodiment, the signal (hereinafter, a request signal) for the control request may include information of the NFT. The information of the NFT may include control information for the IoT device. The control information may include a range of authority capable of controlling the IoT device and a function (e.g., a temperature control, an air volume control and the like, in case that the IoT device is an air conditioner) included in the authority capable of controlling. The information may include a period when the IoT device is capable of being controlled. The control information may include product information (e.g., a type, and a product number) of the IoT device. The control information may include a fee for purchasing the authority capable of controlling the IoT device. The control information may include renewal information (e.g., a due date, the number of renewals, and a renewal fee) on the authority capable of controlling the IoT device. The control information may include position information of the IoT device. For example, at least a portion of the control information may be encrypted in a private state via contents locking in a process of generating (or minting) the NFT.

According to an embodiment, the metaverse server 720 may deliver the request signal received from the other electronic device 740 to the IoT server 710. The IoT server 710 may identify whether the user of the other electronic device 740 is a legitimate user based on the received request signal. For example, the IoT server 710 may transmit the control information received from the other electronic device 740 to the blockchain network 750. Accordingly, the IoT server 710 may verify whether the user has legitimate authority via the blockchain network 750.

In an embodiment, in case that the verification is legitimate, the IoT server 710 may transmit a signal for a control command to the IoT device 730. For example, the signal for the control command may include a command for the control operation transmitted by the other electronic device 740. The command may be identified based on the command information transmitted from the other electronic device 740. The IoT server 710 may receive a result performed based on the control command from the IoT device 730. The IoT server 710 may transmit the received result to the metaverse server 720.

In an embodiment, the metaverse server 720 may display another virtual object based on the result. For example, the metaverse server 720 may replace and display the virtual object displaying the IoT device based on the NFT with the other virtual object displaying the IoT device in a changed state according to the result. However, an embodiment of the present disclosure is not limited thereto. For example, the metaverse server 720 may display the other virtual object for displaying the changed state together with the virtual object while displaying the virtual object as it is in the virtual space. Herein, a meaning that the metaverse server 720 displays the virtual object may include generating information for displaying the virtual object and transmitting the information to the other electronic device 740.

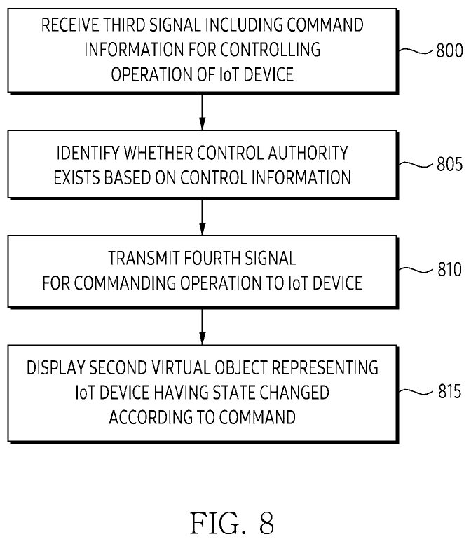

FIG. 8 illustrates an example of a flowchart of a server for controlling an electronic device via a visual object displayed based on an NFT in a virtual space according to an embodiment. In an embodiment of FIG. 8, the server may include the server 200 of FIG. 2 and the server 700 of FIG. 7. The server may include an IoT server (e.g., the IoT server 210 of FIG. 2, and the IoT server 710 of FIG. 7), and a metaverse server (e.g., the metaverse server 220 of FIG. 2, and the metaverse server 720 of FIG. 7)).

In FIG. 8, although illustrated based on an operation of the server, an embodiment of the present invention is not limited thereto. An embodiment of the present disclosure may include an operation of an IoT server or an operation of a metaverse server included in the server.

According to an embodiment, in an operation 800, the server may receive a third signal including command information for controlling an operation of an IoT device. For example, the server may receive the third signal from an electronic device (e.g., another electronic device 740 of FIG. 7) of a user who purchased an NFT related to the IoT device. For example, the third signal may include control information for the IoT device and the command information for controlling the operation of the IoT device. The control information may include a range of authority capable of controlling the IoT device and a function (e.g., a temperature control, an air volume control and the like, in case that the IoT device is an air conditioner) included in the authority capable of controlling. The control information may include a period when the IoT device is capable of being controlled. The control information may include product information (e.g., a type, and a product number) of the IoT device. The control information may include a fee for purchasing the authority capable of controlling the IoT device. The control information may include renewal information (e.g., a due date, the number of renewals, and a renewal fee) of the authority capable of controlling the IoT device. The control information may include position information of the IoT device. For example, at least a portion of the control information may be encrypted in a private state via contents locking in a process of generating (or minting) the NFT. For example, the metaverse server included in the server may receive the third signal from the electronic device. For example, the command information may include information for controlling the operation of the IoT device generated based on user input information obtained as the electronic device identifies an input (e.g., a user input).

In an embodiment, in an operation 805, the server may identify whether control authority exists based on the control information. For example, the server may identify, via a blockchain network, whether the authority for the electronic device to control the IoT device exists. For example, the server may transmit the control information to the blockchain network. The blockchain network may identify whether the user of the electronic device has the control authority by comparing information of the NFT related to the control information. For example, the metaverse server included in the server may transmit the control information and information on the command for the control operation to the IoT server included in the server. For example, the IoT server may identify whether the control authority exists by transmitting the control information to the blockchain network.

Although not illustrated in FIG. 8, the server may receive a result of identifying whether the control authority exists from the blockchain network. For example, the IoT server included in the server may receive the result from the blockchain network.

According to an embodiment, in an operation 810, the server may transmit a fourth signal for commanding an operation to the IoT device. For example, the server may transmit the command identified based on the command information received from the electronic device to the IoT device. For example, the IoT server included in the server may transmit the fourth signal to the IoT device.

Although not illustrated in FIG. 8, the server may receive a result of the command from the IoT device. For example, the IoT server included in the server may receive the result of the command. The IoT server may deliver the received result of the command to the metaverse server included in the server.

According to an embodiment, in an operation 815, the server may display a second virtual object representing the IoT device having a state changed according to the command. For example, the server may identify that the state of the IoT device is changed based on the result of the command. The server may display the second virtual object for representing the IoT device in the changed state. For example, the server may generate information for displaying the second virtual object and transmit the generated information to the electronic device. For example, the metaverse server included in the server may generate information for displaying the second virtual object and transmit the generated information to the electronic device. The electronic device may display the second virtual object via an output device (e.g., a display) of the electronic device based on the received information.

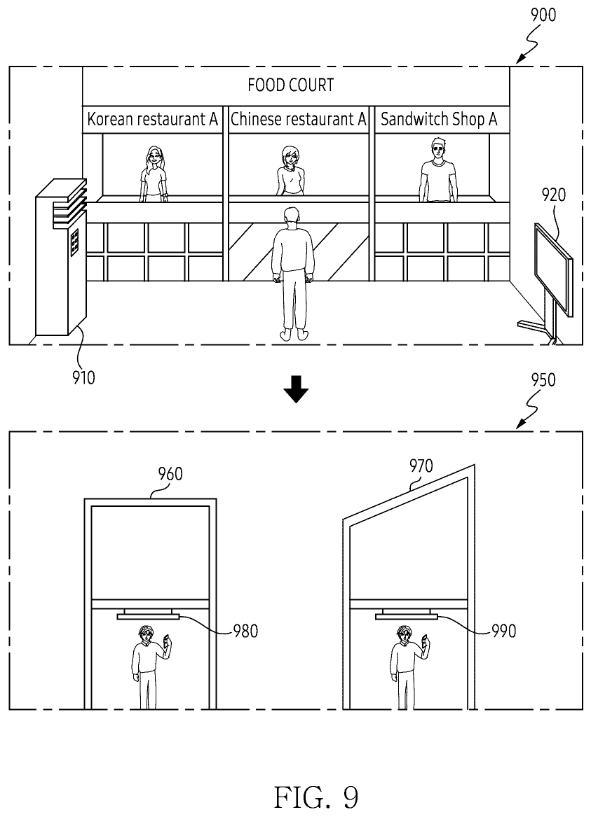

FIG. 9 illustrates an example in which a purchasable NFT is changed according to a position of a user according to an embodiment. The user may indicate a user who purchased an NFT from another user who generated the NFT. For example, the user may indicate a user of an electronic device (e.g., the other electronic device of FIG. 2, the other electronic device 540 of FIG. 5, or the other electronic device 740 of FIG. 7). For example, the other user may indicate a user of another electronic device (e.g., the electronic device of FIG. 2, and the electronic device 340 of FIG. 3).

Examples 900 and 950 of FIG. 9 illustrate an example of purchasing a control right of IoT devices via an NFT for the IoT devices in a public place and controlling the IoT devices using the control right. The example 900 illustrates an example in which the user positioned in a mart in the real world controls IoT devices in the mart. The example 950 illustrates an example of controlling an IoT device for each of different buildings in the real world.

Referring to the example 900, the user may perform control of an air conditioner 910 or a TV 920 positioned in a food court of a mart. In an embodiment, the user may purchase a control right (or an NFT) of the air conditioner 910 or the TV 920 by accessing an NFT server or a metaverse server using an electronic device (e.g., a HMD, a terminal, or a PC). For example, the electronic device may purchase the control right via a virtual object corresponding to the air conditioner 910 or the TV 920 in a virtual space provided by the metaverse server. Alternatively, the electronic device may purchase the control right (or the NFT) via the visual object corresponding to the air conditioner 910 or the TV 920 via a web page provided by the NFT server. In an embodiment, after purchasing the NFT, the user may perform control of the air conditioner 910 or the TV 920 by requesting control of the virtual object in the metaverse server via the electronic device. In an embodiment, the user being positioned in the mart may be identified via a sensor (e.g., a GPS) of the electronic device. In an embodiment, the NFT server or the metaverse server connected to the electronic device may display an NFT corresponding to a region of the real world in which the user is positioned via the visual object or the virtual object.

In an embodiment, when the NFT is minted, based on position information of the IoT device included in the NFT, the NFT server or the metaverse server may identify whether it corresponds to the region of the real world in which the user is positioned. For example, the position information of the IoT device may be generated in a public state when the NFT is minted.

Referring to the example 950, the user may perform control of air conditioners 980 and 990 positioned in different buildings 960 and 970. In an embodiment, the user may purchase a control right (or an NFT) of the air conditioners 980, and 990 by accessing an NFT server or a metaverse server using an electronic device (e.g., the HMD, the terminal, or the PC). For example, the electronic device may purchase the control right via virtual objects corresponding to the air conditioners 980 and 990 in a virtual space provided by the metaverse server. Alternatively, the electronic device may purchase the control right (or the NFT) via visual objects corresponding to the air conditioners 980 and 990 via a web page provided by the NFT server. In an embodiment, after purchasing the NFT, the user may perform control of the air conditioners 980 and 990 by requesting control of the virtual object in the metaverse server via the electronic device. In an embodiment, the user being positioned in the mart may be identified via a sensor (e.g., a GPS) of the electronic device. In an embodiment, the NFT server or the metaverse server connected to the electronic device may display an NFT corresponding to a region of the real world in which the user is positioned via the visual object or the virtual object. For example, in case that the user is positioned in the first building 960, the NFT server or the metaverse server may display an NFT of the air conditioner 980 via the visual object or the virtual object. Unlike this, in case that the user is positioned in the second building 970, the NFT server or the metaverse server may display an NFT of the air conditioner 990 via the visual object or the virtual object.

In an embodiment, when the NFT is minted, the NFT server or the metaverse server may identify whether it corresponds to the region of the real world in which the user is positioned based on the position information of the IoT device included in the NFT. For example, the position information of the IoT device may be generated in a public state when the NFT is minted.

As described above, according to an embodiment, a method performed by a server 200 may comprise receiving, from a first electronic device 240 or 340, a first signal including control information for an internet of things (IoT) device 230. The method may comprise obtaining a non-fungible token (NFT) including the control information. The method may comprise, in response to receiving, from the first electronic device 240 or 340, a second signal, displaying, via a virtual space, a first virtual object representing the IoT device. The method may comprise receiving, from a second electronic device 240, 540, or 740 obtaining the control information via the first virtual object in the virtual space, a third signal including command information controlling an operation of the IoT device. The method may comprise, in response to receiving the third signal, transmitting, to the IoT device, a fourth signal for commanding an operation of the IoT device and displaying, via the virtual space, a second virtual object representing the IoT device changed according to a result of the command.

For example, the NFT may be minted via a blockchain network connected to the server. The control information included in the NFT may include identification information for indicating the NFT, a right capable of controlling the IoT device and a range of the right, a period of the right, and information on the IoT device.

For example, the control information included in the NFT may include information indicating whether the NFT has been renewed, a due date being capable of renewing the NFT, and a fee for renewing the NFT.

For example, the method may comprise receiving, from the first electronic device, the first signal by an IoT server connected to the IoT device in the server. The method may comprise transmitting, to the IoT device, the fourth signal by the IoT server.

For example, the method may comprise receiving, from the second electronic device, the third signal for controlling the IoT device by a metaverse server managing the virtual space in the server. A signal for requesting a control of the IoT device may be transmitted from the metaverse server to the IoT server in response to the third signal. The result of the command may be transmitted from the IoT server to the metaverse server.

For example, in response to identifying that a position of the IoT device is a region corresponding to a position of a user of the second electronic device, a virtual object for the NFT may be displayed via the virtual space to a virtual object corresponding to the user of the second electronic device.

For example, the method may comprise receiving, from the second electronic device, the third signal by a metaverse server managing the virtual space in the server. A signal for requesting a control of the IoT device may be transmitted from the metaverse server to the IoT server in response to the third signal. The result of the command may be transmitted from the IoT server to the metaverse server.

For example, in response to identifying that a position of the IoT device is a region corresponding to a position of a user of the second electronic device, a virtual object for the NFT may be displayed via the virtual space to a virtual object corresponding to the user of the second electronic device.

For example, the method may comprise identifying information indicating whether to disclose position information of the IoT device included in the first signal and the method may comprise in response to identifying to be disclosed the position information of the IoT device, generating the NFT including the control information including the position information. The control information included in the NFT may include the position information of the IoT device.

For example, the first virtual object may be represented as a two-dimensional (2D) image or a three-dimensional (3D) image in the virtual space.

As described above, according to an embodiment, a method performed by an internet of things (IoT) server managing an IoT device may comprise receiving, from a first electronic device, a first signal including control information for the IoT device. The method may comprise transmitting, to a blockchain network connected to the IoT server, a signal for requesting to generate a non-fungible token (NFT) including the control information for the IoT device. The method may comprise receiving, from a metaverse server managing a virtual space, a signal including command information controlling an operation of the IoT device based on the NFT. The method may comprise transmitting, to the IoT device, the signal including the command information. The method may comprise receiving, from the IoT device, a result of the command. A first virtual object representing the IoT device may be displayed via the virtual space based on the NFT. A second virtual object representing the IoT device changed according to the result may be displayed via the virtual space.

For example, the NFT may be minted via the blockchain network. The control information included in the NFT may include identification information for indicating the NFT, a right capable of controlling the IoT device and a range of the right, a period of the right, and information on the IoT device.

For example, the control information included in the NFT may comprise information indicating whether the NFT has been renewed, a due date being capable of renewing the NFT, and a fee for renewing the NFT.

For example, in response to identifying that a position of the IoT device is a region corresponding to a position of a user of the second electronic device, a virtual object for the NFT may be displayed via the virtual space to a virtual object corresponding to the user of the second electronic device.

For example, the method may comprise identifying information indicating whether to disclose position information of the IoT device included in the first signal. The method may comprise, in response to identifying to be disclosed the position information of the IoT device, transmitting the signal for requesting to generate the NFT including the control information including the position information. The control information included in the NFT may include the position information of the IoT device.

For example, the first virtual object may be represented as a two-dimensional (2D) image or a three-dimensional (3D) image in the virtual space.

As described above, according to an embodiment, a method performed by a metaverse server managing a virtual space may comprise, in response to a request of an internet of things (IoT) server managing an IoT device, receiving, from a blockchain network connected to the metaverse server, a non-fungible token (NFT) including control information for the IoT device. The method may comprise, in response to receiving a request signal from a first electronic device providing the control information, displaying a first virtual object representing the IoT device via the virtual space. The method may comprise receiving, from a second electronic device obtaining the control information via the first virtual object, a signal including command information controlling an operation of the IoT device. The method may comprise, in response to receiving the signal including the command information, transmitting, to the IoT server, a signal for commanding an operation of the IoT device. The method may comprise, in response to receiving, from the IoT server, a result of the command, displaying a second virtual object representing the IoT device via the virtual space.

For example, the NFT may be minted via a blockchain network connected to the server. The control information included in the NFT may include identification information for indicating the NFT, a right capable of controlling the IoT device and a range of the right, a period of the right, and information on the IoT device.

For example, the control information included in the NFT may include information indicating whether the NFT has been renewed, a due date being capable of renewing (updating) the NFT, and a fee for renewing (updating) the NFT.

For example, in response to identifying that a position of the IoT device is a region corresponding to a position of a user of the second electronic device, a virtual object for the NFT may be displayed via the virtual space to a virtual object corresponding to the user of the second electronic device.

For example, in case that a signal including the control information transmitted by the first electronic device to the IoT server instructs disclosure position information of the IoT device, the control information included by the NFT may include the position information of the IoT device.

For example, the first virtual object may be represented as a two-dimensional (2D) image or a three-dimensional (3D) image in the virtual space.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

1. A method performed by a server comprising:
receiving, from a first electronic device, a first signal including control information for an internet of things (IoT) device;
obtaining a non-fungible token (NFT) including the control information;
based on receiving, from the first electronic device, a second signal, displaying, via a virtual space, a first virtual object representing the IoT device;
receiving, from a second electronic device obtaining the control information via the first virtual object in the virtual space, a third signal including an instruction to control an operation of the IoT device; and
based on receiving the third signal, transmitting, to the IoT device, a fourth signal requesting an operation of the IoT device and displaying, via the virtual space, a second virtual object representing the IoT device changed according to a result of the instruction.

2. The method of claim 1,
wherein the NFT is minted via a blockchain network connected to the server, and
wherein the control information included in the NFT includes:
identification information for indicating the NFT,
information associated with a right associated with control of the IoT device and a range of the right,
a period of the right, and
information associated with the IoT device.

3. The method of claim 2,
wherein the control information included in the NFT includes information indicating whether the NFT has been renewed, a due date of renewing the NFT, and a fee for renewing the NFT.

4. The method of claim 1, the method comprising:
receiving, from the first electronic device, the first signal by an IoT server connected to the IoT device in the server, and
transmitting, to the IoT device, the fourth signal by the IoT server.

5. The method of claim 4, the method comprising:
receiving, from the second electronic device, the third signal by a metaverse server managing the virtual space in the server, and
wherein a signal for requesting a control of the IoT device is transmitted from the metaverse server to the IoT server based on the third signal, and
wherein the result of the instruction is transmitted from the IoT server to the metaverse server.

6. The method of claim 1,
wherein, based on identifying that a position of the IoT device is a region corresponding to a position of a user of the second electronic device, a virtual object for the NFT is displayed via the virtual space to a virtual object corresponding to the user of the second electronic device.

7. The method of claim 1, the method comprising:
identifying information indicating whether to publish position information of the IoT device included in the first signal; and
based on identifying to be disclosed the position information of the IoT device, generating the NFT including the control information including the position information, and
wherein the control information included in the NFT includes the position information of the IoT device.

8. The method of claim 1,
wherein the first virtual object is represented as a two-dimensional (2D) image or a three-dimensional (3D) image in the virtual space.

9. A method performed by an internet of things (IoT) server managing an IoT device,
receiving, from an electronic device, a first signal including control information for the IoT device;
transmitting, to a blockchain network connected to the IoT server, a signal for requesting to generate a non-fungible token (NFT) including the control information for the IoT device;
receiving, from a metaverse server managing a virtual space, a signal including an instruction to control an operation of the IoT device based on the NFT;
transmitting, to the IoT device, the signal including the instruction; and
receiving, from the IoT device, a result of the instruction,
wherein a first virtual object representing the IoT device is displayed via the virtual space based on the NFT, and
wherein a second virtual object representing the IoT device changed according to the result is displayed via the virtual space.

10. The method of claim 9,
wherein the NFT is minted via the blockchain network, and
wherein the control information included in the NFT includes:
identification information for indicating the NFT,
information associated with a right associated with control of the IoT device and a range of the right,
a period of the right, and
information associated with the IoT device.

11. The method of claim 10,
wherein the control information included in the NFT includes information indicating whether the NFT has been renewed, a due date associated with renewing the NFT, and a fee for renewing the NFT.

12. The method of claim 9, wherein the electronic device is a first electronic device,
wherein, based on identifying that a position of the IoT device is a region corresponding to a position of a user of a second electronic device, a virtual object for the NFT is displayed via the virtual space to a virtual object corresponding to the user of the second electronic device.

13. The method of claim 9, the method comprising:
identifying information indicating whether to disclose position information of the IoT device included in the first signal; and
based on identifying to be disclosed the position information of the IoT device, transmitting the signal for requesting to generate the NFT including the control information including the position information, and
wherein the control information included in the NFT includes the position information of the IoT device.

14. The method of claim 9,
wherein the first virtual object is represented as a two-dimensional (2D) image or a three-dimensional (3D) image in the virtual space.

15. A method performed by a metaverse server managing a virtual space,
based on a request of an internet of things (IoT) server managing an IoT device, receiving, from a blockchain network connected to the metaverse server, a non-fungible token (NFT) including control information for the IoT device;
based on receiving a request signal from a first electronic device providing the control information, displaying a first virtual object representing the IoT device via the virtual space;
receiving, from a second electronic device obtaining the control information via the first virtual object, a signal including an instruction to control an operation of the IoT device;
based on receiving the signal including the instruction, transmitting, to the IoT server, a signal to request an operation of the IoT device; and
based on receiving, from the IoT server, a result of the instruction, displaying a second virtual object representing the IoT device via the virtual space.

16. The method of claim 15,
wherein the NFT is minted via a blockchain network connected to the server, and
wherein the control information included in the NFT includes:
identification information for indicating the NFT,
information associated with a right associated with control of the IoT device and a range of the right,
a period of the right, and
information associated with the IoT device.

17. The method of claim 16,
wherein the control information included in the NFT includes information indicating whether the NFT has been renewed, a due date of renewing the NFT, and a fee for renewing the NFT.

18. The method of claim 15,
wherein, based on identifying that a position of the IoT device is a region corresponding to a position of a user of the second electronic device, a virtual object for the NFT is displayed via the virtual space to a virtual object corresponding to the user of the second electronic device.

19. The method of claim 15,
wherein, a signal including the control information transmitted by the first electronic device to the IoT server instructs to publish position information of the IoT device, the control information included in the NFT includes the position information of the IoT device.

20. The method of claim 15,
wherein the first virtual object is represented as a two-dimensional (2D) image or a three-dimensional (3D) image in the virtual space.
